(19) United States
(12) Patent Application Publication
(10) Pub. No.: US 2008/0317958 A1
(43) Pub. Date: Dec. 25, 2008

(54) Pigmented ink-jet ink with improved highlighter smear

(76) Inventors: Jayprakash C. Bhatt, Corvallis, OR (US); Richard J. McManus, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/820,865

(22) Filed: Jun. 20, 2007

(51) Int. Cl. C09D 11/02; B05D 1/36

(52) U.S. Cl. 427/258; 106/31.6; 106/31.85; 106/31.86

(57) ABSTRACT

Compositions, systems, and methods of printing an ink-jet image are provided. The composition can be an ink-jet ink, comprising a liquid vehicle, a pigmented colorant, and a wax emulsion. The wax emulsion can be present at from about 0.1 wt % to about 20 wt %, preferably 0.1 wt % to 10 wt %, and more preferably from 0.1 wt % to 5 wt % solid content of the ink-jet ink composition. Additionally, upon printing the ink-jet ink on a media substrate compared to printing a comparative ink-jet ink composition on a media substrate, the ink-jet ink composition exhibits improved alkaline highlighter smear fastness compared to the comparative ink-jet ink composition.

### FIELD OF THE INVENTION

The present invention relates generally to ink-jet ink compositions. More particularly, the present invention relates to pigment-based ink-jet inks that have been formulated with polymeric emulsion, including polymeric wax emulsions for improving highlighter smear.

### BACKGROUND OF THE INVENTION

There are several reasons that ink-jet printing has become a popular way of recording images on various media surfaces, particularly paper. Some of these reasons include low printer noise, capability of high-speed recording, and multi-color recording. Additionally, these advantages can be obtained at a relatively low price to consumers. Though there has been great improvement in ink-jet printing, accompanying this improvement are increased demands by consumers in this area, e.g., higher speeds, higher resolution, full color image formation, increased stability, improved durability, improved highlighter smear, etc.

As new ink-jet inks are developed, there have been several traditional characteristics to consider when evaluating the ink in conjunction with a printing surface or substrate, particularly when talking about text black inks. Such characteristics include high optical density of the image on the surface, low wicking, low black to color bleed and low highlighter smear. Though the above list of characteristics provides a worthy goal to achieve, there are difficulties associated with satisfying all of the above characteristics. Often, the inclusion of an ink component meant to satisfy one of the above characteristics can prevent another characteristic from being met. Thus, most commercial inks for use in ink-jet printers represent a compromise in an attempt to achieve at least an adequate response in meeting all of the above listed requirements.

One characteristic of ink-jet printing systems that is desirable to achieve is related to print quality and reduced highlighter smear. Particularly, it is desirable to reduce highlighter smear with both alkaline based and acid based highlighters while minimizing any significant decline in print quality, optical density, wicking, black to color bleed, etc., particularly when printed on plain paper. The use of traditional binders for achieving improved highlighter smear has not proven particularly successful, as there is a limit as to what can be added imposed by ink-jet architecture reliability requirements. As such, investigations continue in improving these characteristics, while maintaining good ink-jet architecture reliability.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a pigment” includes reference to one or more of such materials.

As used herein, “liquid vehicle” is defined to include liquid compositions that can be used to carry colorants, including pigments, to a substrate. Liquid vehicles are well known in the art, and a wide variety of ink vehicles may be used in accordance with embodiments of the present invention. Such ink vehicles may include a mixture of a variety of different agents, including without limitation, surfactants, solvents, co-solvents, buffers, biocides, viscosity modifiers, sequestering agents, stabilizing agents, and water. Though not part of the liquid vehicle per se, in addition to the colorants, the liquid vehicle can carry solid additives such as polymers, latex particulates, UV curable materials, plasticizers, salts, etc. Further, in accordance with embodiments of the present invention, the liquid vehicle can also carry a polymeric emulsion, including a polymeric wax emulsion.

As used herein, “pigment” refers to a colorant particle which is typically substantially insoluble in the liquid vehicle in which it is present. Pigments can be traditionally dispersed pigments where a dispersing agent is added with standard pigments, or alternatively, the pigments can be self-dispersed pigments.

“Self-dispersed pigment,” or a derivation thereof, refers to pigments that have been functionalized with dispersing agent, such as by chemical attachment of the dispersing agent to the surface of the pigment. The dispersing agent can be a small molecule or a polymer. In one embodiment, dispersing agents can be attached to such pigments to provide the outer shell of the pigment with a charge, thereby creating a repulsive nature that reduces agglomeration of pigment particles within the liquid vehicle.

The term “polymer-attached pigment” or “polymer-dispersed pigment” refers to a type of self-dispersed pigment wherein a polymer is attached to at least an outer shell of the pigment. Examples of polymers that can be attached to the pigment include styrene maleic anhydrides, polyethylene imine/phthalic anhydrides, polyethylene imine/phenylsuccinic anhydrides, polyethylene imine/succinic anhydrides, pentaethylene hexamines, polyethylene imines, polyurethanes, polyureas, acrylic polymers, vinyl polymers, polypyrrolidones, epoxies, polyesters, polysaccharides, polypeptides, celluloses, polyquats, polyamines, and copolymers thereof.

The term “small molecule-attached pigment” or “small molecule-dispersed pigment” refers to a type of self-dispersed pigment wherein a non-polymeric small molecule is attached to at least an outer shell of the pigment. Examples of small molecules that can be attached to the pigment include carboxyl groups, sulfonic groups, isophthalic groups. The term “emulsion” generally shall include mixtures of nonpolar materials and polar materials, and can include the presence of an emulsifier and/or a surfactant. Traditionally, emulsions have been defined as compositions that can be subject to separation, creaming, and/or cracking, and define dispersions having particle sizes up to about 1000 nm in size, e.g., from less than 20 nm to 1000 nm. Emulsions are also defined as stable suspensions of liquid or oil droplets in a continuous phase.

The term “wax” encompasses a large range of naturally occurring and synthetic material constituted from high fatty acid esters or from other similar polymers. It is important to note that the chemical composition alone does not determine a wax. The term “wax” should rather be seen as a generic term for materials that are or have the following properties: solid at 20° C., varying in consistency from soft and plastic to brittle and hard; a melting point of at least 40° C. without decomposing, which distinguishes waxes from oils and from natural resins; a relatively low viscosity at temperature slightly above the melting point; and non-stringing but producing droplets, which exclude most resins and plastics. Non-limiting examples of naturally occurring waxes or wax combinations containing naturally occurring waxes include beeswax, lanolin, lancerin, shellac, ozokerite, carnauba, candelilla, jojoba, bayberry, rice bran, peat, ouricouri, monton, paraffin, and microcrystalline. Non-limiting examples of synthetic waxes include_fatty acid amides, polyethylene, polypropylene, PTPE, fatty alcohols, polyamides, and combinations thereof.

The term “plain paper” includes any uncoated paper where paper fibers are predominantly present at the outermost printing surface.

The term “smear fastness” or “smear resistance” are used interchangeably and refers to the resistance of a print to blurring when stroked with a highlighter marker. The highlighter marker can be either acid based or alkaline based. Smear fastness is measured in milli optical density (milli OD) and measures the smeared portion of the image outside of the originally printed sample image. In other words, smear fastness is tested by measuring the milli OD of the smeared trail, and not a reduction in optical density of the originally printed image. Thus, a lower value of milli OD indicates improved smear fastness. For example, it is noted that upon printing an ink-jet ink on a media substrate compared to printing a comparative ink-jet ink composition on a media substrate, the ink-jet ink composition exhibits improvement in acidic or alkaline highlighter smear fastness compared to the comparative ink-jet ink composition. The smear fastness can be based on measuring the milli OD of a smear trail generated by the acidic or alkaline highlighter. Further, it is noted that the “comparative” ink-jet ink composition is prepared identical to the ink-jet ink composition, except that it replaces the polymeric wax emulsion with an equivalent amount of water.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

Though the benefits of the ink-jet ink compositions are described herein primarily with respect their performance on plain paper, it should be noted that these inks also perform well on other types of media. For example, non-glossy coated papers do not have the same issues with respect to gloss-loss as when the same inks are printed on glossy media; however, similar general image quality improvements can also be achieved when printing on porous, non-glossy coated media as those achieved when printing on plain paper. In other words, the versatility of the inks of the present invention is merely described and defined in accordance with their performance on both plain paper and glossy media (which are very different types of media), and as such, the inks described herein are not limited to printing on these two particular types of media.

In accordance with the present invention, an ink-jet ink composition is provided that includes a liquid vehicle, a pigmented colorant, and a wax emulsion. The wax emulsion can be present at from about 0.1 wt % to about 20 wt %, preferably 0.1 wt % to 10 wt % and more preferably from 0.1 wt % to 5 wt % solid content of the ink-jet ink composition. Additionally, upon printing the ink-jet ink on a media substrate compared to printing a comparative ink-jet ink composition on a media substrate, the ink-jet ink composition exhibits improvement in acidic or alkaline highlighter smear fastness compared to the comparative ink-jet ink composition, wherein the smear fastness is based on measuring the milli OD of a smear trail generated by the acidic or alkaline highlighter. In some embodiments, the ink composition exhibits from about 10% to about 300% improvement, and in other embodiments, the improvement can be greater than 300% in acidic or alkaline highlighter smear fastness compared to the comparative ink-jet ink highlighter smear fastness. It is noted that the comparative ink-jet ink composition is identical to the ink-jet ink composition, except that it replaces the wax emulsion with water.

Without intending to be bound by any particular theory, it is believed that the wax particles migrate to the surface of the substrate if present in sufficient quantity imparting the ability to modify the coefficient of friction between the pigmented ink and the media substrate, thus reducing highlighter smear in both alkaline based and acid based highlighters.

In another embodiment, a method of printing an image can comprise ink-jetting an ink-jet ink composition onto a media substrate. Again, the ink-jet ink composition can include a liquid vehicle, a pigmented colorant, and a wax emulsion. The wax emulsion can be present at from about 0.1 wt % to about 20 wt %, preferably 0.1 wt % to 10 wt %, and more preferably from 0.1 wt % to 5 wt % solid content of the ink-jet ink composition. Additionally, upon printing the ink-jet ink on a media substrate compared to printing a comparative ink-jet ink composition on the media substrate, the ink-jet ink composition exhibits at least three times greater acidic or alkaline highlighter smear fastness compared to the comparative ink-jet ink composition, wherein the smear fastness is based on measuring the milli OD of a smear trail generated by the acidic or alkaline highlighter. It is noted that the comparative ink-jet ink composition is identical to the ink-jet ink composition, except that it replaces the wax emulsion with water.

In another embodiment, a system for printing an image on a media substrate from a single ink set can comprise ink-jetting an ink-jet ink composition onto a media substrate. Again, the ink-jet ink composition can include a liquid vehicle, a pigmented colorant, and a wax emulsion. The wax emulsion can be present at from about 0.1 wt % to about 20 wt %, preferably 0.1 wt % to 10 wt % and more preferably from 0.1 wt % to 5 wt % solid content of the ink-jet ink composition. With respect to the system and method, the images prepared can be ink-jetted onto fibrous plain paper substrates with acceptable results, though other substrates can also be used, e.g., porous media, plastic overhead sheets, etc.

Pigment

In each of these embodiments, the pigment can be any of various types of pigments, including standard milled pigments that are dispersed by a separate dispersing agent, or self-dispersed pigments including polymer dispersed and small molecule dispersed pigments. The term “self-dispersed pigments,” as described previously, includes pigments that have been modified by a polymer or a small molecule. The base pigment that can be modified and used can be of any color, such as black, magenta, cyan, yellow, blue, orange, violet, or pink, for example. Though the present invention can use any color pigment, and though any color of pigment is within the scope of the present invention, black pigments are primarily described herein to favorably illustrate unique advantages of the present invention.

Examples of black pigments that can be used include carbon pigments. The carbon pigment can be almost any commercially available carbon pigment that provides acceptable optical density and print characteristics. Carbon pigments suitable for use in the present invention include, without limitation, carbon black, graphite, vitreous carbon, charcoal, and combinations thereof. Such carbon pigments can be manufactured by a variety of known method such as a channel method, a contact method, a furnace method, an acetylene method, or a thermal method, and are commercially available from such vendors as Cabot Corporation, Columbian Chemicals Company, Degussa AG, and E.I. DuPont de Nemours and Company. Suitable carbon black pigments include, without limitation, Cabot pigments such as MONARCH 1400, MONARCH 1300, MONARCH 1100, MONARCH 1000, MONARCH 900, MONARCH 880, MONARCH 800, MONARCH 700, CAB-O-JET 200, and CAB-O-JET 300; Columbian pigments such as RAVEN 7000, RAVEN 5750, RAVEN 5250, RAVEN 5000, and RAVEN 3500; Degussa pigments such as Color Black FW 200, RAVEN FW 2, RAVEN FW 2V, RAVEN FW 1, RAVEN FW 18, RAVEN S160, RAVEN FW S170, Special Black 6, Special Black 5, Special Black 4A, Special Black 4, PRINTEX U, PRINTEX 140U, PRINTEX V, and PRINTEX 140V; and TIPURE R-101 available from Dupont. The above list of pigments includes pigments that can be unmodified pigment particulates, small molecule attached pigment particulates, and polymer-dispersed pigment particulates. Unmodified pigments can be modified with small molecules or polymers to be used in accordance with embodiments of the present invention.

As described previously, small molecule-dispersed pigments refer to a type of self-dispersed pigment wherein a non-polymeric small molecule is attached to at least an outer shell of the pigment. For example, one type of pigment that is considered a small molecule-dispersed pigment is a carbon black pigment having a diazonium salt of an aromatic acid directly attached thereto by a covalent bond to the carbon.

The preparation of polymer-dispersed pigments can be by any of a number of methods. For example, polymeric resins can be attached to pigments by beginning with a diazonium attachment group, which can be attached to a base carbon of the pigment. The intermediate structure can then be treated with appropriate polymers to form anionic, cationic, or nonionic black pigments. The reactive group can be a vinyl sulphone, for example, as vinyl sulphone groups can be a very versatile intermediate to attach polymers to carbon. Amines can readily add to the vinyl bond to form cationic or nonionic pigments. Further, thermal condensation with the amine attached pigments and styrene-acrylic acid polymers can then be used to form anionic pigments, if desired. There are also numerous other methods that can be used to prepare polymer-dispersed pigments, as are known by those skilled in the art.

When selecting polymers for use in attaching to or co-dispersing with pigments, several properties or conditions can be evaluated. For example, polymeric molecular weight and acid number can be considered. Though any functional molecular weight can be used, it has been discovered that polymers having a molecular weight from about 4,000 Mw to 15,000 Mw are particularly desirable for use. The higher molecular weight polymers tend to provide better durability, but also provide higher viscosity, which can be problematic for thermal ink-jet applications. However, there is more chance for particle interaction with the vehicle and with other particles when the polymer strands are long. An example of such a polymer includes styrene-acrylic polymers. Styrene/acrylic polymers, as well as other desirable polymers that can be used, include acid functional groups on the polymer chain.

In still further detail, the pigments of the present invention can be from about 30 nm to about 180 nm in average aggregate particle size. However, sizes outside this range can be used if the pigment can remain dispersed in the liquid vehicle and provide adequate color properties.

Wax Emulsion Additive

The wax additives in the emulsion can be any synthetic or natural wax that provides improved smear fastness when compared to a comparative ink that is otherwise identical (replacing the wax additive with a comparable amount of water). Non-limiting examples of natural waxes used include beeswax, lanolin, lancerin, sheelac, ozokerite, carnauba, candellila, jojoba, bayberry, rice bran, peat, ouricouri, monton, paraffin, and/or microcrystalline waxes. Non-limiting examples of synthetic waxes that can be used include fatty acid amides, PTPE, fatty alcohols, polyamides, and combinations thereof. Additionally, Polypropylene (PP), polyethylene (PE) and poly tetrafluoroethylene (PTFE), although sometimes not referred to as waxes, are very often associated with this class of surface conditioner additives because of the similar effects and performances they can provide. In order for the waxes to have significant impact on the coating or ink properties, the wax of the wax emulsion can migrate to the surface and be present in sufficient quantity at the surface to impart the desired properties. Further, their very fine particle size can provide for an intimate and homogeneous incorporation within other ingredients of the formulation, maximizing the benefits related to highlighter smear discussed herein.

Wax emulsion properties that have an impact on formulation performance as it relates to highlighter smear and other desirable properties include the chemical composition, the molecular weight, the melting point, the hardness and, in case of emulsions or dispersions, the particle size. Dispersion particle size can vary from less than 20 nm and higher, in some cases up to 1000 nm.

With this exemplary list in mind, it is understood that waxes that can be used include materials that often have common characteristics such as: solid at 20° C., a melting point of at least 40° C. without decomposing, and a relatively low viscosity at temperatures slightly above the melting point.

Further, it is noted that the present invention is drawn toward providing inks with improved highlighter smear. If a wax emulsion additive is added to an ink-jet ink and measurable improvement in highlighter smear fastness is not obtained, such inks are not considered to be within the scope of the present invention.

Liquid Vehicle

The ink-jet ink compositions of the present invention are typically prepared using an aqueous formulation or liquid vehicle which can include water, cosolvents, surfactants, buffering agents, biocides, sequestering agents, viscosity modifiers, humectants, binders, and/or other known additives. Typically the ink-jet ink compositions of the present invention have a viscosity of between about 0.8 cps to about 15 cps, and in one embodiment, can be from about 0.8 cps to about 8 cps. In one aspect of the present invention, the liquid vehicle can comprise from about 70 wt % to about 99 wt % of the ink-jet ink composition.

As described, cosolvents can be included in the ink-jet compositions of the present invention. Suitable cosolvents for use in the present invention include water soluble organic cosolvents, but are not limited to, aliphatic alcohols, aromatic alcohols, diols, pyrrolidone, glycol ethers, poly(glycol) ethers, lactams, formamides, acetamides, long chain alcohols, ethylene glycol, propylene glycol, diethylene glycols, triethylene glycols, tetraethylene glycol, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. For example, cosolvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides. Specific examples of cosolvents that are preferably employed in the practice of this invention include, but are not limited to, 1,5-pentanediol, 2-pyrrolidone, 2-ethyl-2-hydroxymethyl-1,3-propanediol, diethylene glycol, 3-methoxybutanol, and 1,3-dimethyl-2-imidazolidinone. Cosolvents can be added to reduce the rate of evaporation of water in the ink-jet to minimize clogging or other properties of the ink such as viscosity, pH, surface tension, optical density, and print quality. The cosolvent concentration can range from about 3 wt % to about 50 wt %. Multiple cosolvents can also be used, as is known in the art.

Various buffering agents or pH adjusting agents can also be optionally used in the ink-jet ink compositions of the present invention. Typical buffering agents include such pH control solutions as hydroxides of alkali metals and amines, such as lithium hydroxide, sodium hydroxide, potassium hydroxide; citric acid; amines such as triethanolamine, diethanolamine, and dimethylethanolamine; hydrochloric acid; and other basic or acidic components which do not substantially interfere with the bleed control or optical density characteristics of the present invention. If used, buffering agents typically comprise less than about 10 wt % of the ink-jet ink composition.

In another aspect of the present invention, various biocides can be used to inhibit growth of undesirable microorganisms. Several non-limiting examples of suitable biocides include benzoate salts, sorbate salts, commercial products such as NUOSEPT (Nudex, Inc., a division of Huls America), UCARCIDE (Union Carbide), VANCIDE (RT Vanderbilt Co.), and PROXEL (ICI Americas) and other known biocides. Typically, such biocides comprise less than about 5 wt % of the ink-jet ink composition and often from about 0.1 wt % to about 0.25 wt %.

In one aspect of the present invention, the ink-jet ink compositions can include standard surfactants such as alkyl polyethylene oxides, alkyl phenyl polyethylene oxides, polyethylene oxide (PEO) block copolymers, acetylenic PEO, PEO esters, PEO amines, PEO amides, and dimethicone copolyols. If used, surfactants can be present at from 0.001 wt % to 10 wt % of the ink-jet ink composition, and in one embodiment, can be present at from 0.001 wt % to 0.1 wt %.

### EXAMPLES

The following example(s) illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the most practical and preferred embodiments of the invention.

### Example 1

### Optical Density and Highlighter Smear Fastness

Each of the two ink-jet ink compositions sold by Hewlett Packard Company as HP94 ink cartridge and HP 88 & HP 88XL ink cartridge containing pigmented black ink are modified as described herein and tested for highlighter smear fastness. Specifically, the inks were diluted with a Jonwax 120 wax emulsion (available from Johnson Polymers, Inc) to incorporate about 1-4 wt % wax in a first group of inks and 1-4 wt % wax in a second group of inks. As a control, unmodified inks are diluted with equal amounts of water. Standard highlighter smear test targets were printed on several different plain papers. The prints were highlighted using an acidic and alkaline highlighter and the milli OD transfer (smear caused by the highlighter outside of the original printed image) was measured. The procedure included, first, printing a square or other image onto a substrate; then, after waiting 1 hour, a highlighter was run across the image and the smear density was measured at a distance of 0.1-0.5 mm from the original printed square. The lower the milli OD transferred, the less smear that occurred. The results of both the acid and alkaline highlighter smear fastness tests when with the wax added at 4 wt % are provided below in Table 1 and Table 2, as follows: The results characterized as relative improvement at 1 wt %, 2 wt %, 3 wt % and 4 wt % of wax additive are provided in Table 3.

TABLE 1
One pass acid highlighter at 4 wt % wax additive

| | | HP 94 Ink + | | HP 88 Ink + |
|---|---|---|---|---|
| | | 4 wt % | | 4 wt % |
| | HP 94 Ink + | Wax | Hp 88 Ink + | Wax |
| | Water | Additive | Water | Additive |
| Paper type | (milli OD) | (milli OD) | (milli OD) | (milli OD) |
| Georgia | 137 | 7 | 90 | 10 |
| Pacific Multi | | | | |
| System | | | | |
| Gilbert Bond | 83 | 0 | 27 | 0 |
| HP Bright | 217 | 0 | 83 | 3 |
| white | | | | |
| HP all-in- | 197 | 0 | 110 | 0 |
| one | | | | |
| HP | 140 | 0 | 53 | 10 |
| advanced | | | | |
| Sabah | 80 | 3 | 97 | 7 |
| forest | | | | |
| industries | | | | |
| Hp multi- | 220 | 0 | 153 | 0 |
| purpose | | | | |

TABLE 2
One pass alkaline highlighter at 4 wt % wax additive

| | | HP 94 Ink + | | |
|---|---|---|---|---|
| | | 4 wt % | | HP 88 Ink + 4 |
| | HP 94 Ink + | Wax | Hp 88 Ink + | wt % Wax |
| | Water | Additive | Water | Additive |
| Paper type | (milli OD) | (milli OD) | (milli OD) | (milli OD) |
| Georgia | 130 | 10 | 107 | 20 |
| Pacific Multi | | | | |
| System | | | | |
| Gilbert Bond | 110 | 0 | 23 | 0 |
| HP Bright | 210 | 30 | 127 | 7 |
| white | | | | |
| HP all-in- | 243 | 10 | 173 | 20 |
| one | | | | |
| HP | 150 | 10 | 93 | 10 |
| advanced | | | | |
| Sabah | 110 | 23 | 93 | 27 |
| forest | | | | |
| industries | | | | |
| Hp multi- | 223 | 10 | 133 | 23 |
| purpose | | | | |

Further, various other tests were conducted at other concentrations of solids, and this data is provided in Tables 3 and 4 as it relates to relative improvement in highlighter smear compared to inks without the wax additive. The formula used to calculate the improvement is as follows:

Relative Improvement in % mOD Transferred=[100*(mOD transfer for Control Ink)−(mOD transfer for Ink with wax additive)]/(mOD transfer for Control Ink)

As an example, Relative % mOD transfer=100*(103-20)/103=81%. The results below are characterized as relative improvement at 1 wt %, 2 wt %, 3 wt % and 4 wt %, as follows:

TABLES 3
Relative % improvement with modified HP 88 Ink using Acid or
Alkaline Highlighter at 1-4 wt % wax solids

| | Relative % Improvement in mOD Transfer for modified HP 88 Ink | | | | | | | |
|---|---|---|---|---|---|---|---|---|
| | Acid Highlighter | | | | Alkaline Highlighter | | | |
| | 1% Wax | 2% Wax | 3% Wax | 4% Wax | 1% Wax | 2% Wax | 3% Wax | 4% Wax |
| | Additive | Additive | Additive | Additive | Additive | Additive | Additive | Additive |
| Georgia | 81% | 65% | 95% | 95% | 48% | 73% | 86% | 92% |
| Pacific | | | | | | | | |
| Multi | | | | | | | | |
| System | | | | | | | | |
| Gilbert | 57% | 0% | 60% | 100% | 20% | 33% | 63% | 100% |
| Bond | | | | | | | | |
| paper | | | | | | | | |
| Hp Bright | 58% | 94% | 96% | 102% | 31% | 79% | 78% | 86% |
| White | | | | | | | | |
| paper | | | | | | | | |
| HP All In | 71% | 91% | 100% | 103% | 47% | 82% | 86% | 96% |
| One paper | | | | | | | | |
| HP | 72% | 91% | 96% | 105% | 53% | 77% | 81% | 93% |
| Advanced | | | | | | | | |
| Paper | | | | | | | | |
| Sabah | 46% | 83% | 77% | 96% | 33% | 18% | 44% | 79% |
| Forest Ind. | | | | | | | | |
| Paper | | | | | | | | |
| HP Multi | 45% | 94% | 100% | 100% | 56% | 73% | 68% | 96% |
| Purpose | | | | | | | | |
| paper | | | | | | | | |

TABLES 4
Relative % improvement with modified HP 94 Ink using Acid or
Alkaline Highlighter at 1-4 wt % wax solids added

| | Relative % Improvement in mOD Transfer for modified HP 94 Ink | | | | | | | |
|---|---|---|---|---|---|---|---|---|
| | Acid Highlighter | | | | Alkaline Highlighter | | | |
| | 1% Wax | 2% Wax | 3% Wax | 4% Wax | 1% Wax | 2% Wax | 3% Wax | 4% Wax |
| | Additive | Additive | Additive | Additive | Additive | Additive | Additive | Additive |
| Georgia | 65% | 86% | 0% | 95% | 71% | 75% | 83% | 92% |
| Pacific | | | | | | | | |
| Multi | | | | | | | | |
| System | | | | | | | | |
| Gilbert | 0% | 57% | 50% | 100% | 33% | 50% | 73% | 100% |
| Bond | | | | | | | | |
| paper | | | | | | | | |
| Hp Bright | 68% | 95% | 86% | 102% | 61% | 59% | 86% | 86% |
| white | | | | | | | | |
| paper | | | | | | | | |
| HP All In | 70% | 103% | 97% | 103% | 52% | 76% | 89% | 96% |
| One paper | | | | | | | | |
| HP | 80% | 87% | 100% | 105% | 71% | 62% | −82% | 93% |
| Advanced | | | | | | | | |
| Paper | | | | | | | | |
| Sabah | 57% | 57% | 91% | 96% | 47% | 67% | 75% | 79% |
| Forest Ind. | | | | | | | | |
| Paper | | | | | | | | |
| HP Multi | 67% | 91% | 100% | 100% | 76% | 63% | 78% | 96% |
| Purpose | | | | | | | | |
| paper | | | | | | | | |

As can be seen from Tables 1-4, the optical density (milli OD) of image transfer or smear when using the inks with wax emulsions was significantly less than the optical density of the images printed with water as a control (Inks 1 and 2 plus Water). A large difference between the test inks and the emulsion inks is indicative of little or no transfer of colorant, and is desirable. In other words, the lower the optical density (milli OD) transferred, the lower the highlighters smear. It is noted that though many inks provided significant improvement in highlighter smear, for some of the samples, the highlighter smear was completely eliminated. Thus, the inks of the present invention, which are formulated with various wax emulsions, show major improvement in highlighter smear with both acidic and alkaline highlighters with no significant trade-offs in other desirable characteristics such as black to color bleed performance or loss in text optical density. It is noted that, often, when a wax additive is added to an ink, there is a small loss in optical density for the ink containing polymeric additive as compared to ink diluted with water. For a very large improvement in highlighter smear, this very small loss in optical density is an acceptable trade off.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. An ink-jet ink composition, comprising:
a) a liquid vehicle;
b) a pigmented colorant; and
c) a polymeric wax emulsion, wherein the solid content of the polymeric wax emulsion is present at from about 0.1 wt % to about 20 wt % of the ink-jet ink composition,
wherein the ink-jet ink composition compared to a comparative ink-jet ink composition exhibits improvement in acidic or alkaline highlighter smear fastness, wherein the smear fastness is based on measuring the milli OD of a smear trail from the printed ink-jet ink and the printed comparison ink-jet ink generated by smearing a acidic or alkaline highlighter across printed ink and comparison ink-jet ink.

2. The composition of claim 1, wherein the pigment is self-dispersed.

3. The composition of claim 2, wherein the self-dispersed pigment is a black pigment.

4. The composition of claim 2, wherein the self-dispersed pigment is a small molecule-dispersed pigment.

5. The composition of claim 2, wherein the self-dispersed pigment is a polymer-dispersed pigment.

6. The composition of claim 1, wherein the wax is a natural wax.

7. The composition of claim 6, wherein the natural wax is selected from beeswax, lanolin, lancerin, sheelac, ozokerite, carnauba, candellila, jojoba, bayberry, rice bran, peat, ouricouri, monton, paraffin, microcrystalline, and mixtures thereof.

8. The composition of claim 1, wherein the wax is a synthetic wax.

9. The composition of claim 8, wherein the synthetic was is selected from fatty acid amides, polyethylene, polypropylene, PTPE, fatty alcohols, polyamides, and mixtures thereof.

10. The composition of claim 1, wherein the wax is present at from about 0.1 wt % to about 5 wt % solid content of the ink-jet ink composition.

11. The composition of claim 1, the ink-jet ink composition exhibits at least 10% greater acidic or alkaline highlighter smear fastness compared to the comparative ink-jet ink composition.

12. The composition of claim 1, the ink-jet ink composition exhibits at least 300% greater acidic or alkaline highlighter smear fastness compared to the comparative ink-jet ink composition.

13. The composition of claim 1, the ink-jet ink composition exhibits no smearing.

14. The composition of claim 1, wherein the liquid vehicle includes at least two solvents selected from a pyrrolidone, an ethylene glycol, and a propanediol.

15. The composition of claim 1, wherein the wax is a blend of synthetic and natural wax.

16. The composition of claim 15, wherein the wax is a paraffin-polyethylene blend.

17. A method of printing an image, comprising ink-jetting the ink-jet ink composition of claim 1 in the form of an image onto a media substrate.

18. A method as in claim 17, wherein the media substrate is a plain paper substrate.

19. A method as in claim 18, further comprising the step of highlighting the image with a highlighter marker.

20. A method as in claim 19, wherein the image is text.

21. A system for printing an image on a media substrate, comprising an ink-jet ink composition as in claim 1, and ink-jet architecture configured for jetting the ink-jet ink composition therefrom.

22. A system as in claim 21, further comprising plain paper.
